(19) United States
(12) Patent Application Publication
(10) Pub. No.: US 2024/0354388 A1
(43) Pub. Date: Oct. 24, 2024

(54) INFORMATION PROCESSING APPARATUS AND CONTROL METHOD

(71) Applicant: Lenovo (Singapore) Pte. Ltd., Singapore (SG)

(72) Inventors: Masashi Nishio, Kanagawa (JP); Yuji Wada, Kanagawa (JP)

(73) Assignee: Lenovo (Singapore) Pte. Ltd., Singapore (SG)

(21) Appl. No.: 18/644,675

(22) Filed: Apr. 24, 2024

(30) Foreign Application Priority Data
Apr. 24, 2023 (JP) 2023-070810

(51) Int. Cl. G06F 21/32; G06V 40/16; G06V 40/50

(52) U.S. Cl. CPC G06F 21/32; G06V 40/166; G06V 40/172; G06V 40/50

(57) ABSTRACT

An information processing apparatus includes: a memory which temporarily stores a program of a system; a first processor which executes face detection processing to detect an area of each of face images with a face captured therein from among captured images captured by an imaging unit, and face authentication processing to authenticate the face based on information on the detected face image and information on a face image of an authorized user; and a second processor which executes the program of the system to boot the system from a standby state based on a fact that the area of the face image is detected by the face detection processing and face authentication by the face authentication processing is successful.

### CROSS-REFERENCE TO RELATED APPLICATIONS

This application claims priority to Japanese Patent Application No. 2023-070810 filed on Apr. 24, 2023, the contents of which are hereby incorporated herein by reference in their entirety.

### TECHNICAL FIELD

The present invention relates to an information processing apparatus and a control method.

### BACKGROUND

There is an information processing apparatus which makes a transition to a usable state when a person approaches or to a standby state in which functions except some of the functions are stopped when the person moves away. For example, in Japanese Unexamined Patent Application Publication No. 2016-148895, it is detected whether a person is approaching or has moved away using an infrared sensor.

In recent years, with the development of computer vision and the like, detection accuracy when detecting a face from an image has been getting higher. Therefore, face detection has started to be used instead of the person detection by the infrared sensor. Further, upon boot of the information processing apparatus, user authentication (for example, login authentication) is performed to determine whether or not a user is an authorized user. As this authentication method, face authentication has been used. For example, when a person approaches, the information processing apparatus is booted by detecting a face of the person, and when the person is an authorized user as a result of performing login authentication such as face authentication, login to the system is allowed and the information processing apparatus makes a transition to the usable state.

In the method of booting the information processing apparatus by face detection as described above, there is a problem that the information processing apparatus is booted up even when any person other than the authorized user approaches. In order to solve this problem, it is considered a method of registering, as a face of the authorized user, a face detected when authentication, for example, by the login authentication is successful to perform face authentication in addition to face detection upon bootup. However, since the face is not always facing forward when the authentication by the login authentication is successful, the face not facing forward may be registered even if the face is the face of the authorized user. In this case, the face of the authorized user may not be able to be authenticated properly, and hence the information processing apparatus may not be able to be booted, for example, even if the authorized user approaches.

### SUMMARY

One or more embodiments of the present invention provide an information processing apparatus and a control method capable of authenticating a face of an authorized user properly.

An information processing apparatus according to one or more embodiments of the present invention includes: a memory which temporarily stores a program of a system; a first processor which executes face detection processing to detect an area of each of face images with a face captured therein from among captured images captured by an imaging unit, and face authentication processing to authenticate the face based on information on the detected face image and information on a face image of an authorized user; and a second processor which executes the program of the system to boot the system from a standby state based on the fact that the area of the face image is detected by the face detection processing and face authentication by the face authentication processing is successful, wherein after the system is booted up, the second processor executes system authentication processing to authenticate whether or not the face image is the face image of the authorized user by processing of the system, and the first processor registers, as the information based on the face image of the authorized user, information based on a face image when an orientation of the face becomes a specific orientation among face images detected by the face detection processing within a predetermined time period after authentication by the system authentication processing is successful.

The above information processing apparatus may be such that the specific orientation is an orientation based on a direction of the imaging unit.

The above information processing apparatus may also be such that the first processor detects a face angle of the face image detected from among the captured images within the predetermined time period, and determines that the orientation of the face becomes the specific orientation when the detected face angle is within a predetermined angle range based on the direction of the imaging unit.

The above information processing apparatus may further be such that the first processor increases a frequency of detecting areas of the face images from the captured images within the predetermined time period more than a frequency of detecting the areas of the face images from the captured images in the standby state.

Further, the above information processing apparatus may be such that, upon registering the information based on the face image of the authorized user, the first processor newly registers the information when the information based on the face image of the authorized user is not registered yet, or updates the registered information when the information based on the face image of the authorized user is already registered.

Further, the above information processing apparatus may be such that, when the information based on the face image of the authorized user is not registered yet, the second processor boots the system from the standby state based on the fact that the area of the face image is detected from among the captured images captured by the imaging unit in the standby state.

Further, the above information processing apparatus may be such that, when the area of the face image is no longer detected from among the captured images captured by the imaging unit after the system is booted up, the second processor causes the system to make the transition to the standby state.

Further, the above information processing apparatus may be such that even when the area of the face image is detected from among the captured images captured by the imaging unit after the system is booted up, the second processor will cause the system to make the transition to the standby state if face authentication by the face authentication processing is unsuccessful.

Further, a control method for an information processing apparatus according to one or more embodiments of the present invention is a control method for an information processing apparatus including a memory which temporarily stores a program of a system, a first processor, and a second processor, the control method including: a step of causing the first processor to perform face detection processing to detect an area of each of face images with a face captured therein from among captured images captured by an imaging unit; a step of causing the first processor to perform face authentication processing to authenticate the face based on information on the detected face image and information on a face image of an authorized user; a step of causing the second processor to boot the system from a standby state by executing the program of the system based on the fact that the area of the face image is detected by the face detection processing and face authentication by the face authentication processing is successful; a step of causing the second processor to execute system authentication processing to authenticate whether or not the face image is the face image of the authorized user by processing of the system after the system is booted up; and a step of causing the first processor to register, as the information based on the face image of the authorized user, information based on a face image when an orientation of the face becomes a specific orientation among face images detected by the face detection processing within a predetermined time period after authentication by the system authentication processing is successful.

One or more embodiments of the present invention can authenticate a face of an authorized user properly.

### BRIEF DESCRIPTION OF THE DRAWINGS

FIGS. 1(A)-1(C) are diagrams for describing an overview of HPD processing of an information processing apparatus according to one or more embodiments.

FIG. 2 is a diagram illustrating an example of a person detection range of the information processing apparatus according to one or more embodiments.

FIG. 3 is a diagram illustrating an outline of HPD processing using an HPD user ID of the information processing apparatus according to one or more embodiments.

FIG. 4 is a perspective view illustrating an appearance configuration example of the information processing apparatus according to one or more embodiments.

FIG. 5 is a diagram illustrating an example of the hardware configuration of the information processing apparatus according to one or more embodiments.

FIG. 6 is a diagram illustrating an example of the functional configuration of the information processing apparatus according to one or more embodiments.

FIG. 7 is a flowchart illustrating an example of HPD processing in a standby state according to one or more embodiments.

FIG. 8 is a flowchart illustrating an example of login authentication processing by face authentication according to one or more embodiments.

FIG. 9 is a flowchart illustrating an example of HPD user ID registration/update processing according to one or more embodiments.

FIG. 10 is a flowchart illustrating an example of HPD user ID registration processing according to one or more embodiments.

FIG. 11 is a flowchart illustrating an example of HPD user ID update processing according to one or more embodiments.

FIG. 12 is a flowchart illustrating an example of HPD processing in a normal operating state according to one or more embodiments.

### DETAILED DESCRIPTION

Embodiments of the present invention will be described below with reference to the accompanying drawings.

First, the overview of an information processing apparatus according to one or more embodiments will be described. An information processing apparatus 1 according to one or more embodiments is, for example, a laptop (clamshell) PC (Personal Computer). Note that the information processing apparatus 1 may also be any other type of information processing apparatus such as a desktop PC, a tablet PC, or a smartphone.

The information processing apparatus 1 can make a transition, as the operating state of the system, at least between a normal operating state (power-on state) and a standby state. The normal operating state is an operating state capable of executing processing without being particularly limited, which corresponds, for example, to S0 state defined in the ACPI (Advanced Configuration and Power Interface) specification. The standby state is a state in which part of system processing is limited. For example, the standby state may be the standby state or a sleep state, Modern Standby in Windows (registered trademark), or a state corresponding to S3 state (sleep state) defined in the ACPI specification. For example, the standby state is an operating state lower in power consumption than the normal operating state.

In the following, a transition of the system operating state from the standby state to the normal operating state may also be called “boot.” For example, since the standby state is lower in the activation level of the operation than the normal operating state, the boot of the system of the information processing apparatus 1 leads to the activation of the operation of the system in the information processing apparatus 1.

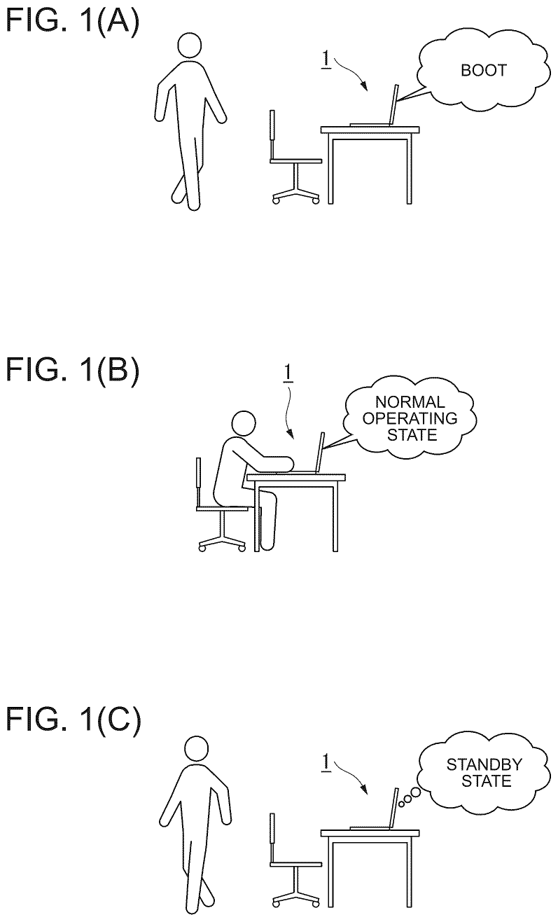

FIGS. 1(A)-1(C) are diagrams for describing an overview of HPD processing of the information processing apparatus 1 according to one or more embodiments. The information processing apparatus 1 detects a person (that is, a user) present in the neighborhood of the information processing apparatus 1. This processing to detect the presence of a person is called HPD (Human Presence Detection) processing. The information processing apparatus 1 detects the presence or absence of a person by the HPD processing to control the operating state of the system of the information processing apparatus 1 based on the detection result. For example, as illustrated in FIG. 1(A), when detecting a change from a state where no person is present in front of the information processing apparatus 1 (Absence) to a state where a person is present (Presence), that is, when detecting that a person has approached the information processing apparatus 1 (Approach), the information processing apparatus 1 determines that the user has approached, and automatically boots the system to make a transition to the normal operating state. Further, in a state where a person is present in front of the information processing apparatus 1 (Presence) as illustrated in FIG. 1(B), the information processing apparatus 1 determines that the user is present, and continues the normal operating state. Then, as illustrated in FIG. 1(C), when detecting a change from the state where the person is present in front of the information processing apparatus 1 (Presence) to the state where no person is present (Absence), that is, when detecting that the person has left the information processing apparatus 1 (Leave), the information processing apparatus 1 determines that the user has left and causes the system to make a transition to the standby state.

The information processing apparatus 1 detects the presence of a person in a predetermined forward range.

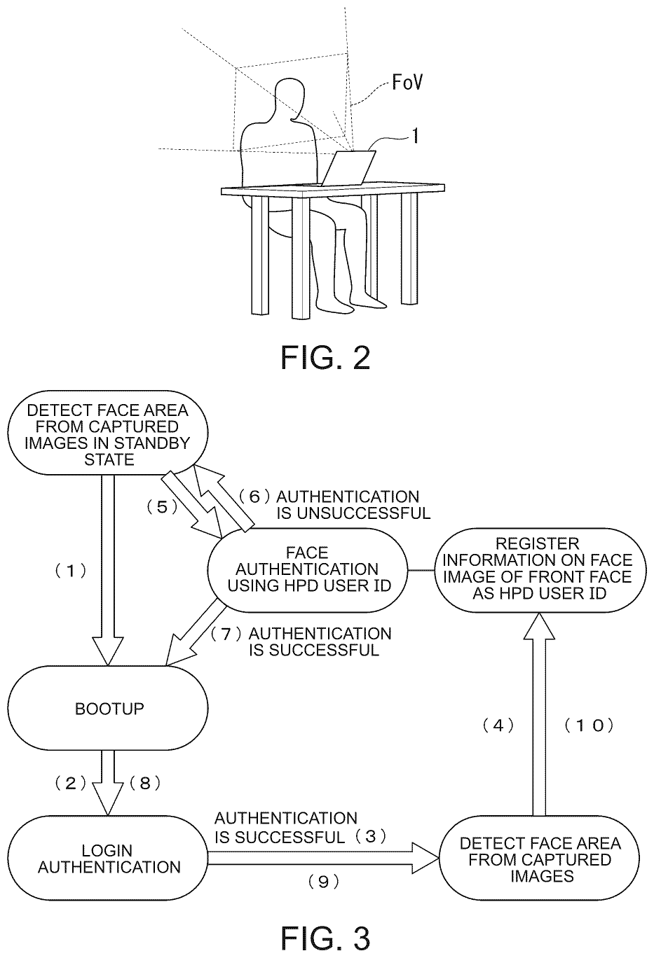

FIG. 2 is a diagram illustrating an example of a person detection range of the information processing apparatus 1 according to one or more embodiments. In the illustrated example, a detection range FoV (Field of View: detection viewing angle) in front of the information processing apparatus 1 is a person detectable range. For example, the information processing apparatus 1 detects an area of a face image (hereinafter called a “face area”) with a face captured therein from a captured image captured by imaging forward (front side) to determine whether or not a person (user) is present in front of the information processing apparatus 1. The detection range FoV corresponds to an imaging angle of view at which the information processing apparatus 1 captures an image. When the face area is detected from the captured image, the information processing apparatus 1 determines that the user is present. On the other hand, when no face area is detected from the captured image, the information processing apparatus 1 determines that the user is not present.

For example, when it is determined that the user is present by detecting the face area from the captured image in the standby state, the information processing apparatus 1 boots the system from the standby state. Further, after the system is booted up, the information processing apparatus 1 executes system authentication processing to authenticate whether or not the user is an authorized user by system processing. The authorized user is a user preregistered as a user who uses the information processing apparatus 1. When determining that the user is the authorized user, the information processing apparatus 1 allows the use of the information processing apparatus 1 (allows the login), and makes a transition to the normal operating state. On the other hand, when determining that the user is not the authorized user, the information processing apparatus 1 continues waiting for authentication without allowing the use (without allowing the login). This user authentication by the system authentication processing upon bootup is called “login authentication” below.

As the login authentication method, there are password authentication to authenticate a password input by the user from the keyboard, PIN authentication to authenticate a PIN (Personal Identification Number) input by the user, face authentication to authenticate a face of the user, fingerprint authentication to authenticate a fingerprint of the user, and the like. When the login authentication by face authentication is enabled, the information processing apparatus 1 performs face authentication by matching feature information based on a face image in the face area detected from the captured image with feature information based on a face image of the preregistered, authorized user.

Here, in a case where the system is booted from the standby state only by the face detection to detect the face area from the captured image in the HPD processing, the information processing apparatus 1 boots the system even when a person other than the authorized user has approached. Therefore, the information processing apparatus 1 registers a user ID (hereinafter called an “HPD user ID”) to authenticate whether or not the person is the authorized user in the HPD processing based on the authentication result upon login authentication.

For example, when the login authentication is successful after the system is booted up, it is assumed that the authorized user is present in front of the information processing apparatus 1. Therefore, the information processing apparatus 1 detects a face area from a captured image captured when the login authentication is successful, and sets the detected face image as the face image of the authorized user to register feature information based on the face image as the HPD user ID. In the case where the face area is detected from the captured image in the HPD processing, the information processing apparatus 1 performs control to boot the system when the feature information is registered as the HPD user ID or to make the transition to the standby state when the feature information is not registered as the HPD user ID.

Although high power consumption is allowed to enable highly accurate face authentication when face authentication is performed upon login authentication, it is desirable to reduce power consumption as much as possible when HPD processing is performed in the standby state. For example, in the case of the face authentication in the login authentication, a captured image captured by an IR (Infrared Rays) camera is used, while in the case of the face authentication in the HPD processing in the standby state, a captured image captured by an RGB camera is used. Further, the frame rate at which the captured image used for the face authentication in the HPD processing in the standby state is captured is set lower than the frame rate at which the captured image used for the face authentication in the login authentication.

Due to the difference between the face authentication at the time of the login authentication and the face authentication in the HPD processing as mentioned above, the face authentication in the login authentication is possible, for example, even when the face orientation is tilted at about ±20° from the front, but it can be authenticated as the same face only in a range in which the face orientation is tilted at about ±15° from the front in the case of the face authentication in the HPD processing. Therefore, it is desirable to register, as the HPD user ID, feature information based on a face image of a face as close to the front face as possible. Note that the face orientation is front is an orientation in which the face faces the direction of an imaging unit such as the IR camera or the RGB camera mentioned above, that is, in a state where the front face is captured in a captured image.

For example, the information processing apparatus 1 registers, as the HPD user ID, the feature information based on the face image when the face turned to the front within a predetermined time period (for example, within five seconds) after the login authentication is successful. The reason why it is limited to within the predetermined time period (for example, within five seconds) is to reduce the possibility of being replaced with a user other than the authorized user.

FIG. 3 is a diagram illustrating an outline of HPD processing using the HPD user ID according to one or more embodiments. Referring to FIG. 3, the outline of HPD processing according to one or more embodiments will be described in the order of (1) to (8). In the following, captured images captured by the RGB camera when the information processing apparatus 1 images forward (front side) in the standby state are called “first captured images.” On the other hand, captured images captured by the IR camera when the information processing apparatus 1 images forward (front side) upon login authentication after the system is booted up are called “second captured images.”

(1) The information processing apparatus 1 detects a face area from among the first captured images captured by the RGB camera in the standby state to boot the system. Note that the HPD user ID is not registered at this time.

(2) The information processing apparatus 1 performs login authentication to allow only the authorized user to use the information processing apparatus 1 after bootup. For example, the information processing apparatus 1 detects a face area from the second captured images captured by the IR camera in the event of the login authentication after bootup, and executes face authentication processing based on a face image in the detected face area. Note that the authentication method for the login authentication may also be any authentication method other than that for the face authentication.

(3) The information processing apparatus 1 detects a face area from among the first captured images captured by the RGB camera within the predetermined time period (for example, within five seconds) after the login authentication is successful.

(4) The information processing apparatus 1 registers, as the HPD user ID, feature information on a face image when the face turned to the front within the predetermined time period (for example, within five seconds) based on the face area detected from among the first captured images captured by the RGB camera.

(5) Next, when the face area is detected from among the first captured images captured by the RGB camera in the standby state, the information processing apparatus 1 performs face authentication to authenticate whether or not a user in the face area is the authorized user using the HPD user ID registered at (4) mentioned above. For example, when the face area is detected from among the first captured images in the standby state, the information processing apparatus 1 performs face authentication by matching feature information based on a face image in the detected face area with the HPD user ID.

(6) When the face authentication at (5) is unsuccessful, the information processing apparatus 1 determines that the user is not the authorized user, and continues the standby state without booting the system.

(7) On the other hand, when the face authentication at (5) is successful, the information processing apparatus 1 determines that the user is the authorized user, and boots the system.

(8) Like at (2) mentioned above, the information processing apparatus 1 performs login authentication processing after bootup.

Then, like at (3) and (4) mentioned above, the information processing apparatus 1 registers (updates), as the HPD user ID, feature information based on a face image when the face turned to the front within the predetermined time period (for example, within five seconds) after the login authentication is successful based on the face area detected from among the first captured images captured by the RGB camera in a flow of (9) and (10).

After that, a flow of (5) to (10) is repeated. Thus, since the information processing apparatus 1 registers, as the HPD user ID, feature information based on a face image when the face turned to the front within the predetermined time period (for example, within five seconds) after the login authentication is successful to perform the face authentication using the HPD user ID in the HPD processing, the face of the authorized user can be authenticated properly.

Next, the configurations of the information processing apparatus 1 according to one or more embodiments will be described in detail.

### [Appearance Configuration of Information Processing Apparatus]

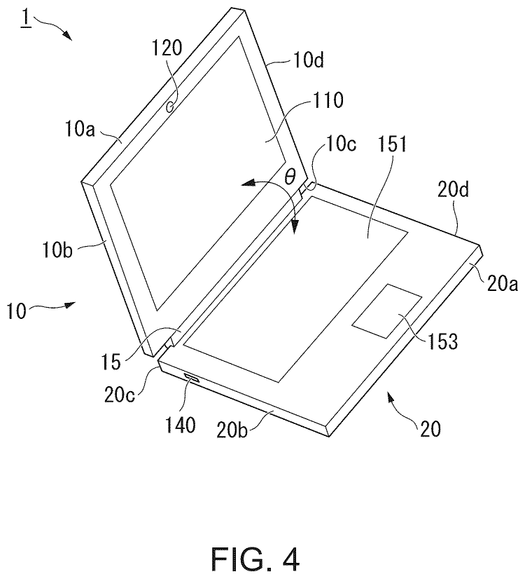

FIG. 4 is a perspective view illustrating an appearance configuration example of the information processing apparatus 1 according to one or more embodiments.

The information processing apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “θ” in FIG. 4.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c to the side face 20a is referred to as “front.” The right hand and left hand in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle θ=0°) is referred to as a “closed state.” The faces of the first chassis 10 and the second chassis 20 on the face-to-face sides in the closed state are referred to as respective “inner faces,” and the faces opposite to the inner faces are referred to as “outer faces.” Further, a state opposite to the closed state, where the first chassis 10 and the second chassis 20 are open, is referred to as an “open state.”

The appearance of the information processing apparatus 1 in FIG. 4 illustrates an example of the open state. The open state is a state where the side face 10a of the first chassis 10 and the side face 20a of the second chassis 20 are separated. In the open state, the respective inner faces of the first chassis 10 and the second chassis 20 appear. The open state is one of states when the user uses the information processing apparatus 1, and the information processing apparatus 1 is often used in a state where the open angle is typically about θ=100° to 130°. Note that the range of open angles θ to be the open state can be set arbitrarily according to the range of angles rotatable by the hinge mechanism 15 or the like.

A display unit 110 is provided on the inner face of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner face of the first chassis 10. For example, the imaging unit 120 is arranged on the side of the side face 10a in the peripheral area of the display unit 110. Note that the position at which the imaging unit 120 is arranged is just an example, and it may be elsewhere as long as the imaging unit 120 can image a direction (frontward) to face the inner face of the first chassis 10.

In the open state, the imaging unit 120 images a predetermined imaging range in the direction (frontward) to face the inner face of the first chassis 10. The predetermined imaging range is a range of angles of view defined by an image sensor included in the imaging unit 120 and an optical lens provided in front of the imaging surface of the image sensor, which corresponds to the person (face) detection range FoV illustrated in FIG. 2. For example, the imaging unit 120 can capture an image including a person (for example, the user) present in front of the information processing apparatus 1.

Further, a power button 140 is provided on the side face 20b of the second chassis 20. The power button 140 is an operating element used by the user to give an instruction to power on or power off, the transition from the standby state to the normal operating state, the transition from the normal operating state to the standby state, or the like. Further, a keyboard 151 and a touch pad 153 are provided on the inner face of the second chassis 20 as an input device. Note that a touch sensor may also be included as the input device instead of or in addition to the keyboard 151 and the touch pad 153, or a mouse and an external keyboard may be connected. When the touch sensor is provided, an area corresponding to the display surface of the display unit 110 may be constructed as a touch panel. Further, a microphone used to input voice may be included in the input device.

### [Hardware Configuration of Information Processing Apparatus]

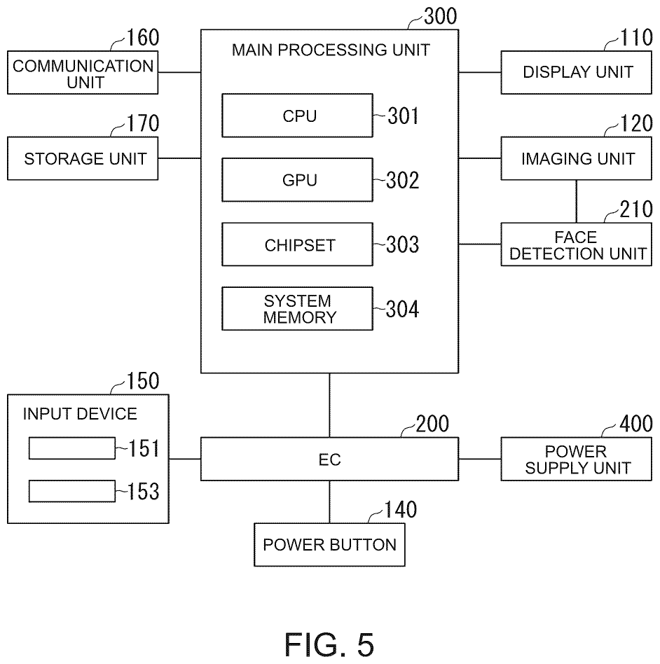

FIG. 5 is a schematic block diagram illustrating an example of the hardware configuration of the information processing apparatus 1 according to one or more embodiments. The information processing apparatus 1 is configured to include the display unit 110, the imaging unit 120, the power button 140, an input device 150, a communication unit 160, a storage unit 170, an EC (Embedded Controller) 200, a face detection unit 210, a main processing unit 300, and a power supply unit 400. The display unit 110 displays display data (images) generated based on system processing executed by the main processing unit 300, processing of an application program(s) running on the system processing, and the like.

The imaging unit 120 captures an image of an object within a predetermined angle of view (for example, within the detection range FoV illustrated in FIG. 2) in a direction (frontward) to face the inner face of the first chassis 10, and outputs the captured image to the face detection unit 210 and the main processing unit 300. For example, the imaging unit 120 includes an RGB camera and an IR (Infrared Rays) camera. The RGB camera is a normal camera to capture images based on visible light. The IR camera is a camera to capture images based on infrared rays emitted from the object.

Since the IR camera irradiates infrared rays, for example, upon imaging, power consumption upon imaging is higher than that of the RGB camera. Therefore, for example, the RGB camera is used when detecting the face area from among the first captured images in the standby state to reduce standby power as much as possible. On the other hand, for example, the IR camera is used when detecting the face area from among the second captured images in the login authentication by the face authentication to perform face authentication in order to increase the authentication accuracy. Note that both the IR camera and the RGB camera may also be used upon the login authentication by the face authentication.

The power button 140 outputs, to the EC 200, operation signals according to user's operations. The input device 150 is an input unit for accepting user input, which is configured to include, for example, the keyboard 151 and the touch pad 153. In response to accepting operations on the keyboard 151 and the touch pad 153, the input device 150 outputs, to the EC 200, operation signals indicative of the operation contents.

The communication unit 160 is connected to other devices communicably through a wireless or wired communication network to transmit and receive various data. For example, the communication unit 160 is configured to include a wired LAN interface such as the Ethernet (registered trademark), a wireless LAN interface such as Wi-Fi (registered trademark), and the like.

The storage unit 170 is configured to include storage media, such as an HDD (Hard Disk Drive) or an SDD (Solid State Drive), a RAM (Random Access Memory), a ROM (Read Only Memory), and the like. The storage unit 170 stores an OS, device drivers, various programs such as applications, and various data acquired by the operation of the programs.

The power supply unit 400 supplies power to each unit of the information processing apparatus 1 according to the operating state of each unit. The power supply unit 400 includes a DC (Direct Current)/DC converter. The DC/DC converter converts the voltage of DC power, supplied from an AC (Alternate Current)/DC adapter or a battery (battery pack), to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM, a ROM, an I/O (Input/Output) logic circuit, and the like. The CPU of the EC 200 reads a control program (firmware) prestored in the own ROM and executes the read control program to fulfill the functionality. The EC 200 operates independently of the main processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The face detection unit 210 is configured to include a processor to process image data of a captured image captured by the imaging unit 120. The face detection unit 210 acquires the image data of the captured image captured by the imaging unit 120, and temporarily stores the acquired image data in a memory. The memory in which the image data is stored may be a system memory 304, or an unillustrated memory in the face detection unit 210.

For example, the face detection unit 210 processes the image data of the captured image acquired from the imaging unit 120, and performs face detection processing to detect a face area from the captured image, face authentication processing to authenticate a face image in the detected face area, and the like. The face detection unit 210 transmits, to a chipset 303 of the main processing unit 300, the detection result of the face detection processing, the authentication result of the face authentication processing, and the like.

Note that the face detection unit 210 is operating not only in the normal operating state but also in the standby state. In the standby state, the face detection unit 210 acquires image data of the first captured images captured, for example, by the RGB camera of the imaging unit 120 to detect a face area. By imaging using the RGB camera without using the IR camera, power consumption in the standby state (standby power) can be reduced. On the other hand, in the login authentication processing after bootup, since the face detection unit 210 acquires image data of the second captured images captured by the IR camera (or by both the RGB camera and the IR camera) of the imaging unit 120 to perform the face area detection and the face authentication, the accuracy of the face authentication can be increased.

For example, the face detection unit 210 performs the face authentication using the HPD user ID registered when the login authentication processing is successful in the HPD processing described with reference to FIG. 3. The functional configuration in this HPD processing will be described in detail later.

The main processing unit 300 is configured to include a CPU (Central Processing Unit) 301, a GPU (Graphic Processing Unit) 302, the chipset 303, and the system memory 304, where processing of various application programs is executable on the OS (Operating System) by system processing based on the OS.

The CPU 301 executes BIOS processing, OS processing, processing by application programs running on the OS, and the like. The CPU 301 controls the operating state of the system based on instructions from the chipset 303 and the like. For example, the CPU 301 executes boot processing to boot the system from the standby state. Further, after the system is booted from the standby state, the CPU 301 executes login authentication processing to authenticate whether or not a user is the authorized user, and when the authentication is successful, the CPU 301 makes the transition to the normal operating state.

For example, the CPU 301 executes authentication processing by face authentication in the login authentication. Note that in the login authentication, the CPU 301 may also execute authentication processing other than the face authentication (for example, password authentication, PIN authentication, fingerprint authentication, or the like).

When determining that a user is the authorized user in the login authentication (successful authentication), the CPU 301 allows the use (allows the login), and makes the transition to the normal operating state. On the other hand, when determining that the user is not the authorized user in the login authentication (unsuccessful authentication), the CPU 301 continues waiting for login authentication without allowing the use (without allowing the login).

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, the chipset 303 acquires the detection result of the face detection from the face detection unit 210 in the HPD processing to detect the presence of a person (user) based on the detection result in order to control the operating state of the system.

The system memory 304 is used as a reading area of a program executed by the CPU 301 and a working area to write processed data. Further, the system memory 304 temporarily stores image data of captured images captured by the imaging unit 120.

Note that the CPU 301, the GPU 302, and the chipset 303 may also be integrated as one processor, or some or each of them may be configured as an individual processor, respectively. For example, in the normal operating state, the CPU 301, the GPU 302, and the chipset 303 are all operating, but in the standby state, only at least some of the functions of the chipset 303 are operating. In the standby state, at least only functions required for HPD processing upon bootup are operating.

### [Functional Configuration of Information Processing Apparatus]

Next, a functional configuration in which the information processing apparatus 1 controls the operating state of the system by the HPD processing will be described.

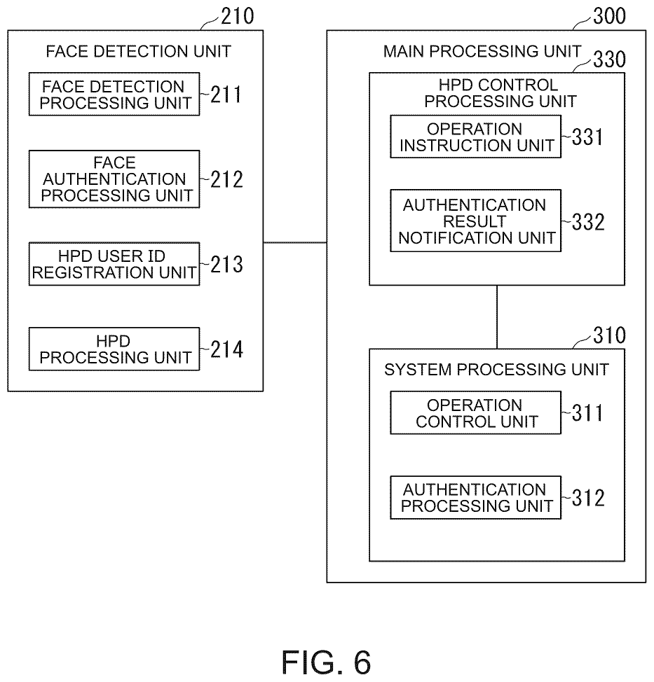

FIG. 6 is a block diagram illustrating an example of the functional configuration of the information processing apparatus 1 according to one or more embodiments. The information processing apparatus 1 includes the face detection unit 210, a system processing unit 310, and an HPD control processing unit 330. The face detection unit 210 corresponds to the face detection unit 210 illustrated in FIG. 5, which is a functional component implemented by executing a program in the face detection unit 210. The system processing unit 310 and the HPD control processing unit 330 are functional components implemented by the main processing unit 300 illustrated in FIG. 5 executing the OS and a program running on the OS. For example, the system processing unit 310 is a functional component by the CPU 301 executing the OS program. Further, the HPD control processing unit 330 is a functional component implemented by the chipset 303 executing the program running on the OS.

The face detection unit 210 includes a face detection processing unit 211, a face authentication processing unit 212, an HPD user ID registration unit 213, and an HPD processing unit 214. Further, the system processing unit 310 includes an operation control unit 311 and an authentication processing unit 312. Further, the HPD control processing unit 330 includes an operation instruction unit 331 and an authentication result notification unit 332.

The face detection processing unit 211 reads, from the system memory 304, image data of captured images captured by the imaging unit 120 at a given frame rate (at a given frequency) to detect a face area from each of the captured images, respectively. As the face detection method, any detection method using a face detection algorithm for detecting a face based on facial feature information, trained data (learned model) subjected to machine learning based on the facial feature information, a face detection library, or the like can be applied. Further, the frame rate when the imaging unit 120 captures images is controlled, for example, to 4 FPS in the standby state, 15 FPS during login authentication, 15 FPS within a predetermined time period (for example, within five seconds) after the login authentication is successful, 1 FPS in the normal operating state, and the like.

For example, in the standby state, the face detection processing unit 211 detects a face area from among first captured images (RGB images) captured at 4 FPS using the RGB camera of the imaging unit 120, and outputs coordinate information and the like of the face area as the detection results. Further, for example, at the time of the login authentication, the face detection processing unit 211 detects a face area from among second captured images (IR images) captured at 15 FPS using the IR camera of the imaging unit 120, and outputs coordinate information and the like of the face area as the detection results. Note that at the time of the login authentication, the face detection processing unit 211 may also detect the face area from among second captured images (IR images and RGB images) captured using the IR camera and the RGB camera of the imaging unit 120.

Further, for example, within the predetermined time period (for example, within five seconds) after the login authentication is successful, the face detection processing unit 211 detects the face area from among the first captured images (RGB images) captured at 15 FPS using the RGB camera of the imaging unit 120, and outputs the coordinate information of the face area, face orientation information, and the like as the detection results. The face orientation information is a face angle of a face image in the detected face area. For example, the face angle is an angle corresponding to the face orientation using the direction of the imaging unit 120 (the direction in which the face is facing forward) as a reference angle (for example, 0°).

Further, for example, in the normal operating state, the face detection processing unit 211 detects the face area from among the first captured images (RGB images) captured at 1 FPS using the RGB camera of the imaging unit 120, and outputs the coordinate information and the like of the face area as the detection results.

The face authentication processing unit 212 executes face authentication processing to authenticate whether or not a face image in the detected face area is a face image of the authorized user. For example, at the time of the login authentication by system processing, the face authentication processing unit 212 performs face authentication by matching the face image detected from among the second captured images (IR images) captured at 15 FPS using the IR camera of the imaging unit 120 with the face image of the authorized user preregistered as user information (account information) for logging in the system. Specifically, for example, at the time of the login authentication, the face authentication processing unit 212 performs the face authentication by matching feature information based on the face image detected from among the second captured images (IR images) with feature information based on the preregistered face image of the authorized user.

Note that the face image of the authorized user registered as the user information (account information) is, for example, a face image detected from among the second captured images (IR images) captured at 15 FPS using the IR camera of the imaging unit 120 on an image registration menu set by the system for face authentication.

Further, the face authentication processing unit 212 performs face authentication based on the feature information on the face image detected from among the first captured images (RGB images) captured at 15 FPS using the RGB camera of the imaging unit 120 in the HPD processing, and the feature information on the face image of the authorized user registered as the HPD user ID. For example, the face authentication processing unit 212 performs the face authentication by matching the feature information based on the face image, detected from among the first captured images (RGB images) captured at 15 FPS using the RGB camera of the imaging unit 120 in the HPD processing, with the feature information based on the face image of the authorized user registered as the HPD user ID.

The HPD user ID registration unit 213 registers, as the HPD user ID (as the feature information based on the face image of the authorized user), feature information based on a face image when the face in the face image detected by the face detection processing unit 211 turned to the front within the predetermined time period (for example, within five seconds) after the authentication by the login authentication processing is successful. For example, the HPD user ID registration unit 213 stores and registers the HPD user ID in the system memory 304 or an unillustrated memory in the face detection unit 210.

For example, when the face angle of the face image detected by the face detection processing unit 211 is within a predetermined angle range (for example, ±15°) based on the direction of the imaging unit 120 (the direction in which the face is facing forward) within the predetermined time period (for example, within five seconds) after the authentication by the login authentication processing is successful, the HPD user ID registration unit 213 determines that the face turned to the front. When the HPD user ID is not registered yet upon registering the HPD user ID, the HPD user ID registration unit 213 newly registers the HPD user ID, while when the HPD user ID is already registered, the HPD user ID registration unit 213 updates the registered HPD user ID.

Based on the detection results of the face detection processing by the face detection processing unit 211 and the authentication result of the face authentication processing by the face authentication processing unit 212, the HPD processing unit 214 outputs information indicative of the detection result of the HPD processing. For example in the case where the HPD user ID is already registered, when the face area is detected from among the first captured images (RGB images) by the face detection processing unit 211 and the face authentication by the face authentication processing unit 212 is successful, the HPD processing unit 214 outputs presence information indicating that the authorized user is present in front of the information processing apparatus 1.

Note that when the HPD user ID is not registered yet, the HPD processing unit 214 outputs the presence information indicating that a user is present in front of the information processing apparatus 1 based on the fact that the face area is detected from among the first captured images (RGB images) by the face detection processing unit 211 in the standby state although it cannot be determined whether or not the user is the authorized user.

On the other hand, when the face area is no longer detected from among the first captured images (RGB images) by the face detection processing unit 211 after the system is booted up, the HPD processing unit 214 outputs absence information indicating that no user is present in front of the information processing apparatus 1. Further, even though the face area is detected from among the first captured images (RGB images) by the face detection processing unit 211 after the system is booted up, when the face authentication by the face authentication processing unit 212 is unsuccessful, since the user present in front of the information processing apparatus 1 is not the authorized user, the HPD processing unit 214 outputs the absence information.

In the standby state, when acquiring the presence information output from the HPD processing unit 214, the operation instruction unit 331 gives an instruction to boot the system from the standby state. For example, the operation instruction unit 331 outputs, to the operation control unit 311, boot instruction information to give the instruction to boot the system from the standby state. Further, in the standby state, the operation instruction unit 331 does not give the instruction to boot the system while acquiring the absence information from the HPD processing unit 214.

Note that when acquiring the absence information from the HPD processing unit 214 in the normal operating state, the operation instruction unit 331 gives an instruction to cause the system to make the transition to the standby state. For example, the operation instruction unit 331 outputs, to the operation control unit 311, standby instruction information indicative of an instruction to cause the system to make the transition to the standby state.

When acquiring the boot instruction information output from the operation instruction unit 331, the operation control unit 311 executes the system program to boot the system from the standby state. Further, the operation control unit 311 causes a login authentication event to occur after the system is booted from the standby state. Then, the operation control unit 311 waits until the authentication is successful without allowing the login. When the authentication becomes successful, the operation control unit 311 allows the login and makes the transition to the normal operating state.

Note that when acquiring the standby instruction information output from the operation instruction unit 331 in the normal operating state, the operation control unit 311 causes the system to make the transition from the normal operating state to the standby state.

When the login authentication event occurs, the authentication processing unit 312 executes the login authentication processing to authenticate whether or not the user is the authorized user. For example, the authentication processing unit 312 executes the login authentication processing by either one of face authentication, password authentication, PIN authentication, and fingerprint authentication. For example, when executing the authentication processing by face authentication, the authentication processing unit 312 acquires the authentication result of the face authentication from the face detection unit 210, and executes the login authentication processing based on the acquired authentication result. The authentication processing unit 312 determines that the user is the authorized user when the authentication is successful, or determines that the user is not the authorized user when the authentication is unsuccessful.

Note that in the case of password authentication or PIN authentication, the authentication processing unit 312 acquires an operation signal based on a user operation on the keyboard 151 through the EC 200. Then, based on the acquired operation signal, the authentication processing unit 312 executes the authentication processing by matching a password or a PIN entered by the user operation with a preregistered password or PIN. Further, in the case of fingerprint authentication, the authentication processing unit 312 executes the authentication processing by matching a fingerprint acquired by using an unillustrated fingerprint sensor with a preregistered fingerprint.

The authentication result notification unit 332 notifies the face detection unit 210 of the authentication result of the login authentication by the authentication processing unit 312. The HPD user ID registration unit 213 of the face detection unit 210 uses the notification of the authentication result of this login authentication as a trigger to register, as the HPD user ID, feature information based on a face image when the face turned to the front within the predetermined time period (for example, within five seconds) after the authentication by the login authentication processing is successful.

### [Operation by HPD Processing]

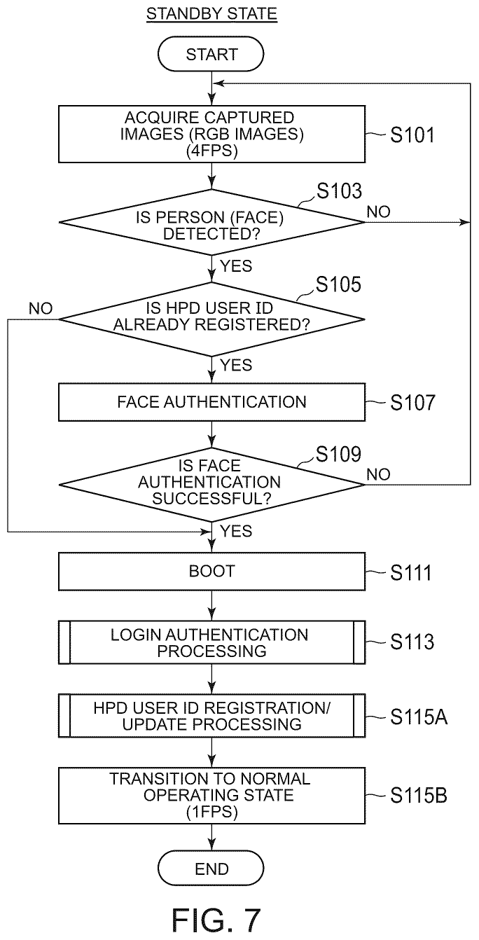

Next, the operation of processing to authenticate the authorized user in the HPD processing in order to control the operating state of the system will be described. Referring first to FIG. 7, the operation of the HPD processing in the standby state will be described. FIG. 7 is a flowchart illustrating an example of the HPD processing in the standby state according to one or more embodiments.

(Step S101) The face detection unit 210 acquires first captured images (RGB images) captured by the imaging unit 120 in the standby state. In the standby state, the first captured images (RGB images) are captured by the imaging unit 120, for example, at a frame rate of 4 FPS. Then, the face detection unit 210 proceeds to a process in step S103.

(Step S103) The face detection unit 210 detects a face area (an area of a face image) from among the first captured images (RGB images) acquired in step S101. When detecting no face area (NO), the face detection unit 210 returns to the process in step S101. On the other hand, when detecting the face area (YES), the face detection unit 210 proceeds to a process in step S105.

(Step S105) The face detection unit 210 determines whether or not the HPD user ID is already registered. When determining that the HPD user ID is not registered yet (NO), the face detection unit 210 proceeds to a process in step S111. On the other hand, when determining that the HPD user ID is already registered (YES), the face detection unit 210 proceeds to a process in step S107.

(Step S107) The face detection unit 210 performs face authentication based on feature information on the face image detected in step S103, and feature information on a face image of the authorized user registered as the HPD user ID. Then, the face detection unit 210 proceeds to a process in step S109.

(Step S109) The face detection unit 210 determines whether or not the face authentication in step S107 is successful. When determining that the face authentication is successful (YES), the face detection unit 210 proceeds to the process in step S111. On the other hand, when determining that the face authentication is unsuccessful (NO), the face detection unit 210 returns to the process in step S101.

(Step S111) The face detection unit 210 outputs presence information. When acquiring the presence information output from the face detection unit 210, the HPD control processing unit 330 outputs, to the system processing unit 310, boot instruction information indicative of an instruction to boot the system from the standby state as a boot instruction by the HPD processing. When acquiring the boot instruction information output from the HPD control processing unit 330, the system processing unit 310 executes the system program to boot the system from the standby state. Note that the system processing unit 310 executes the system program to boot the system from the standby state even when there is a boot instruction other than the boot instruction by the HPD processing (an operation on the power button 140 or the like). Then, the procedure proceeds to a process in step S113.

(Step S113) After booting the system from the standby state, the system processing unit 310 causes the login authentication event to occur to execute the authentication processing in order to authenticate whether or not the user is the authorized user. For example, the system processing unit 310 executes the authentication processing by either one of face authentication, password authentication, PIN authentication, and fingerprint authentication.

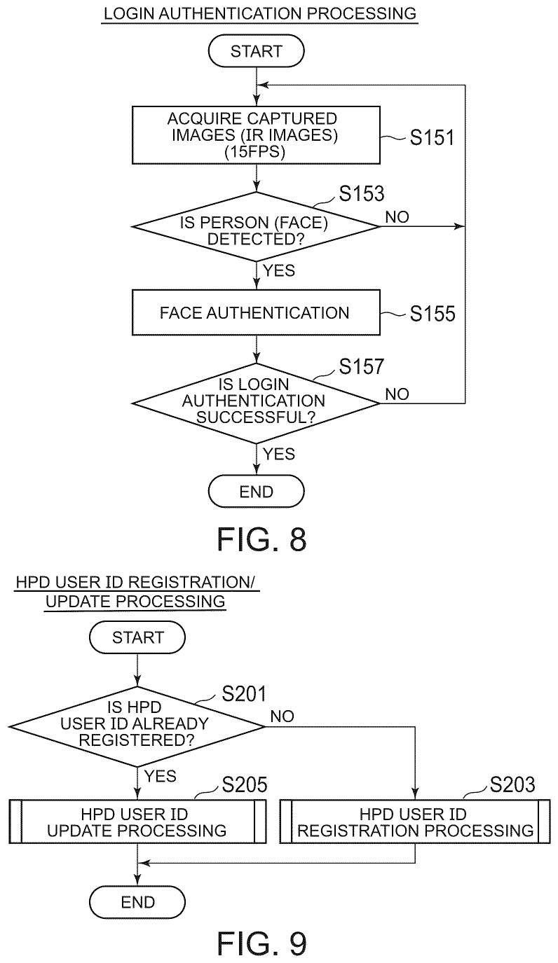

Here, the operation of login authentication processing by face authentication will be described with reference to FIG. 8 as an example of the login authentication processing in step S113.

FIG. 8 is a flowchart illustrating an example of the login authentication processing by face authentication according to one or more embodiments.

(Step S151) When the system processing unit 310 causes the login authentication event to occur, the face detection unit 210 executes the face detection processing and the face authentication processing in the login authentication. First, the face detection unit 210 acquires the second captured images (the IR images, or the IR images and the RGB images) captured by the imaging unit 120. In the login authentication processing, the second captured images (the IR images, or the IR images and the RGB image) are captured by the imaging unit 120, for example, at a frame rate of 15 FPS. Then, the face detection unit 210 proceeds to a process in step S153.

(Step S153) The face detection unit 210 detects a face area from among the second captured images (the IR images, or the IR images and the RGB images) acquired in step S151. When no face area is detected (NO), the face detection unit 210 returns to the process in step S151. On the other hand, when the face area is detected (YES), the face detection unit 210 proceeds to a process in step S155.

(Step S155) The face detection unit 210 performs the face authentication processing based on a face image in a face area detected in step S153. For example, the face detection unit 210 performs the face authentication processing based on the feature information on the face image in the detected face area, and the feature information on the face image of the authorized user preregistered as the user information (account information) for logging in the system, and outputs the authentication result to the system processing unit 310.

(Step S157) Based on the authentication result of the face authentication processing output from the face detection unit 210, the system processing unit 310 determines whether or not the login authentication is successful. For example, when the authentication result of the face authentication processing is unsuccessful (the face authentication is unsuccessful), the system processing unit 310 determines that the login authentication is unsuccessful (NO), and the procedure returns to step S151 without allowing the login. On the other hand, when the authentication result of the face authentication processing is successful (the face authentication is successful), the system processing unit 310 determines that the login authentication is successful (YES), allows the login, and ends the login authentication processing. Further, when the login authentication by the system processing unit 310 is successful, the HPD control processing unit 330 notifies the face detection unit 210 of the authentication result of the login authentication. Then, the procedure proceeds to a process in step S115 of FIG. 7.

Note that the example of the login authentication processing by the face authentication is described here, but even in the case of the login authentication processing by password authentication, PIN authentication, or fingerprint authentication, the procedure is carried out in the same way, that is, when the login authentication is successful, the login is allowed and the login authentication processing is ended, and then the procedure proceeds to processes in step S115A and step S115B of FIG. 7. Note that the order of the processes in step S115A and step S115B is not particularly limited, and these processes are performed in parallel.

(Step S115A) When acquiring the notification of the authentication result of the login authentication in response to the fact that the login authentication by the system processing unit 310 is successful, the face detection unit 210 executes HPD user ID registration/update processing.

(Step S115B) The system processing unit 310 executes the login processing using the account of the authorized user for which the login authentication is successful, and makes the transition to the normal operating state. Note that in the normal operating state, the face detection unit 210 detects a face area from among the first captured images (RGB images) captured by the imaging unit 120, for example, at a frame rate of 1 FPS to execute the HPD processing.

Here, the specific operation of the HPD user ID registration/update processing in step S115A will be described with reference to FIG. 9 to FIG. 11.

FIG. 9 is a flowchart illustrating an example of the HPD user ID registration/update processing according to one or more embodiments.

The face detection unit 210 determines whether or not the HPD user ID is already registered (step S201). When determining that the HPD user ID is not registered yet (NO), the face detection unit 210 proceeds to a process in step S203 to execute HPD user ID registration processing. On the other hand, when determining that the HPD user ID is already registered (YES), the face detection unit 210 proceeds to a process in step S205 to execute HPD user ID update processing.

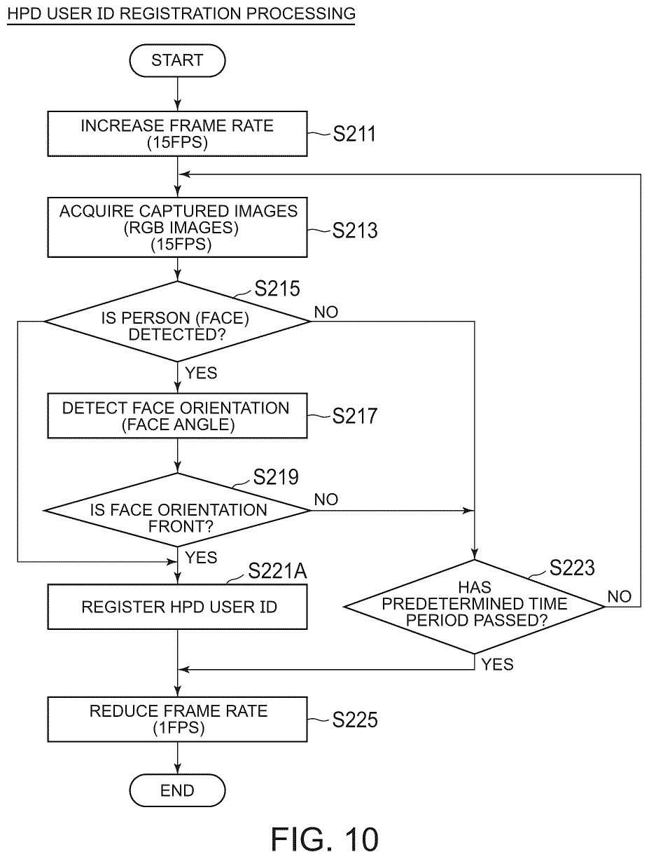

The HPD user ID registration processing in step S203 will be described with reference to FIG. 10. FIG. 10 is a flowchart illustrating an example of the HPD user ID registration processing according to one or more embodiments. In the normal operating state, although the face detection unit 210 detects the face area from among the first captured images (RGB images) captured by the imaging unit 120, for example, at the frame rate of 1 FPS to execute the HPD processing, the face detection unit 210 increases the frame rate upon executing the HPD user ID registration processing and the HPD user ID update processing.

(Step S211) The face detection unit 210 increases the frame rate, for example, to 15 FPS, and proceeds to a process in step S213.

(Step S213) The face detection unit 210 acquires the first captured images (RGB images) captured by the imaging unit 120, for example, at the rate of 15 FPS, and proceeds to a process in step S215.

(Step S215) The face detection unit 210 detects a face area (an area of a face image) from among the first captured images (RGB images) acquired in step S213. When no face area is detected (NO), the face detection unit 210 proceeds to a process in step S223. On the other hand, when the face area is detected (YES), the face detection unit 210 proceeds to a process in step S217.

(Step S217) The face detection unit 210 detects a face orientation (face angle) of the face image in the face area detected in step S215. Then, the face detection unit 210 proceeds to a process in step S219.

(Step S219) The face detection unit 210 determines whether or not the face orientation detected in step S217 is front. For example, when the face angle detected in step S217 is within a predetermined angle range (for example, ±5°) based on the direction of the imaging unit 120 (based on the front where face angle=0°), the face detection unit 210 determines that the face orientation is front. When determining that the face orientation is not front (NO), the face detection unit 210 proceeds to the process in step S223. On the other hand, when determining that the face orientation is front (YES), the face detection unit 210 proceeds to a process in step S221A.

(Step S221A) The face detection unit 210 registers, as the HPD user ID (as feature information based on the face image of the authorized user), feature information based on the face image with the face orientation determined to be front. Then, the face detection unit 210 proceeds to a process in step S225.

(Step S223) The face detection unit 210 determines whether or not the predetermined time period (for example, five seconds) has passed after the login authentication was successful. When determining that the predetermined time period (for example, five seconds) has not passed (NO), the face detection unit 210 returns to the process in step S213. On the other hand, when determining that the predetermined time period (for example, five seconds) has passed (YES), the face detection unit 210 proceeds to a process in step S225.

(Step S225) The face detection unit 210 reduces the frame rate, for example, to 1 FPS, and ends the HPD user ID registration processing.

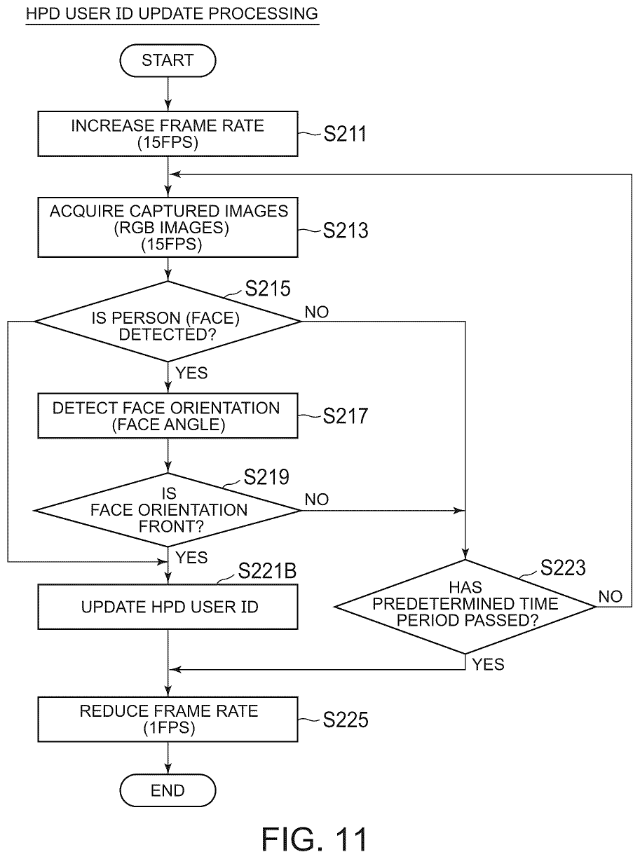

Next, the HPD user ID update processing in step S205 will be described with reference to FIG. 11. FIG. 11 is a flowchart illustrating an example of the HPD user ID update processing according to one or more embodiments. This HPD user ID update processing illustrated in FIG. 11 is different from the HPD user ID registration processing illustrated in FIG. 10 only in a process of step S221B. In step S221B, the face detection unit 210 registers the feature information based on the face image with the face orientation determined to be the front orientation as the HPD user ID instead of the pre-registered HPD user ID to update the HPD user ID. Note that since the processes except for that in step S221B of the HPD user ID update processing are the same as those in the HPD user ID registration processing illustrated in FIG. 10, the description thereof will be omitted.

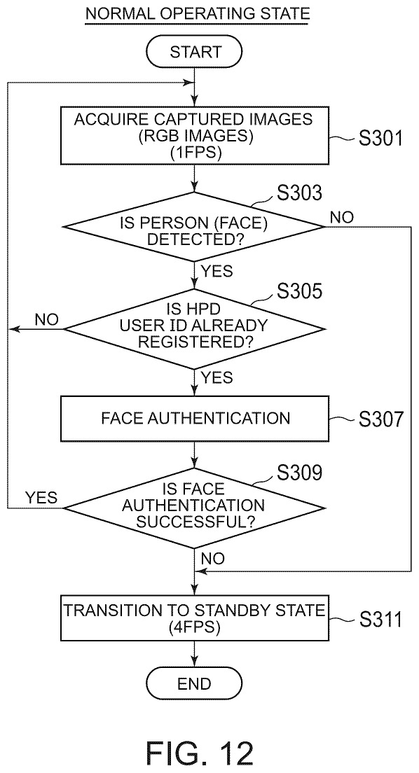

Referring next to FIG. 12, the operation of the HPD processing in the normal operating state will be described. FIG. 12 is a flowchart illustrating an example of the HPD processing in the normal operating state according to one or more embodiments.

(Step S301) The face detection unit 210 acquires the first captured images (RGB images) captured by the imaging unit 120 in the normal operating state. In the normal operating state, the first captured images (RGB images) are captured by the imaging unit 120, for example, at the frame rate of 1 FPS. Then, the face detection unit 210 proceeds to a process in step S303.

(Step S303) The face detection unit 210 detects a face area (an area of a face image) from among the first captured images (RGB images) acquired in step S301. When no face area is detected (NO), the face detection unit 210 proceeds to a process in step S311 because no user is present. On the other hand, when the face area is detected (YES), the face detection unit 210 proceeds to a process in step S305.

(Step S305) The face detection unit 210 determines whether or not the HPD user ID is already registered. When determining that the HPD user ID is not registered yet (NO), the face detection unit 210 returns to the process in step S301. On the other hand, when determining that the HPD user ID is already registered (YES), the face detection unit 210 proceeds to a process in step S307.

(Step S307) The face detection unit 210 performs face authentication based on the feature information on the face image detected in step S303 and the feature information on the face image of the authorized user registered as the HPD user ID. Then, the face detection unit 210 proceeds to a process in step S309.

(Step S309) The face detection unit 210 determines whether or not the face authentication is successful in step S307. When determining that the face authentication is successful (YES), the face detection unit 210 returns to the process in step S301 because the authorized user is present. On the other hand, when determining that the face authentication is unsuccessful (NO), the face detection unit 210 proceeds to a process in step S311 because the person is not the authorized user.

(Step S311) The face detection unit 210 outputs the absence information. When acquiring the absence information output from the face detection unit 210, the HPD control processing unit 330 outputs, to the system processing unit 310, the standby instruction information indicative of the standby instruction to cause the system to make the transition to the standby state as an instruction to make the transition to the standby state by the HPD processing. For example, the HPD control processing unit 330 outputs the standby instruction information to the system processing unit 310 after the state where the absence information output from the face detection unit 210 is being acquired has passed for a certain period of time. When acquiring the standby instruction information output from the HPD control processing unit 330, the system processing unit 310 causes the system to make the transition from the normal operating state to the standby state. Note that even when there is a standby instruction other than the standby instruction by the HPD processing, the system processing unit 310 causes the system to make the transition from the normal operating state to the standby state. The standby instruction other than that by HPD is, for example, that a no-operation state has passed for a certain period of time, that the user performs an operation to bring the system to a sleep state, or the like. Further, in the standby state, the face detection unit 210 acquires the first captured images (RGB images) captured by the imaging unit 120 like in the normal operating state, but the face detection unit 210 switches the frame rate, for example, to 4 FPS. In other words, in the standby state, the face detection unit 210 detects a face area from among the first captured images (RGB images) captured by the imaging unit 120, for example, at 4 FPS to execute the HPD processing.

As described above, the information processing apparatus 1 according to one or more embodiments includes the system memory 304 (an example of a memory) which temporarily stores a program of the system, the face detection unit 210 (an example of a first processor), and the system processing unit 310 (for example, the CPU 301; an example of a second processor). The face detection unit 210 executes face detection processing to detect an area (face area) of each of face images with a face captured therein from among captured images captured by the imaging unit 120, and face authentication processing to authenticate the face based on feature information (an example of information) on the detected face image and feature information (the example of the information) on a face image of an authorized user. The system processing unit 310 executes the program of the system to boot the system from the standby state based on the fact that the face area is detected by the above face detection processing and face authentication by the above face authentication processing is successful. Further, after the system is booted up, the system processing unit 310 executes the login authentication processing (an example of system authentication processing) to authenticate whether or not the face image is the face image of the authorized user by processing of the system. Further, the face detection unit 210 registers, as the feature information based on the face image of the above authorized user (for example, the HPD user ID), feature information based on a face image when an orientation of the face becomes front (an example of a specific orientation) among face images detected by the above face detection processing within a predetermined time period (for example, within five seconds) after authentication by the above login authentication processing is successful.

Thus, upon using the face image of the user, detected when authentication by the login authentication is successful, as the face image of the authorized user for face authentication, since the face image with the face orientation taken into account is used for face authentication, the information processing apparatus 1 can authenticate the face of the authorized user properly.

The fact that the face orientation is front (the example of the specific orientation) described above is an orientation based on the direction of the imaging unit 120.

Thus, since the face image of the front face facing the direction of the imaging unit 120 is used for face authentication, the information processing apparatus 1 can increase the accuracy of face authentication.

For example, the face detection unit 210 detects a face angle of the face image captured from among the captured images within the predetermined time period (for example, within five seconds) after authentication by the login authentication is successful, and determines that the face orientation becomes front (the example of the specific orientation) when the face angle is within a predetermined angle range (for example, within ±5°) based on the direction of the imaging unit 120.

Thus, since the face orientation is determined by detecting the face angle of the detected face image, and the face image of the front face is used for face authentication, the information processing apparatus 1 can increase the accuracy of face authentication.

Further, the face detection unit 210 increases the frame rate (an example of a frequency) of detecting face areas from the captured images within the predetermined time period (for example, within five seconds) after authentication by the login authentication is successful more than the frame rate of detecting face areas from the captured images in the standby state.

Thus, the information processing apparatus 1 can accurately detect the face angle of the face image detected from among the captured images within the predetermined time period (for example, within five seconds) after authentication by the login authentication is successful.

Further, upon registering the HPD user ID (the feature information on the face image of the authorized user), the face detection unit 210 newly registers the HPD user ID when the HPD user ID is not registered yet, or updates the registered information when the HPD user ID is already registered.

Thus, since the HPD user ID is updated to the latest information, the information processing apparatus 1 can authenticate the face of the authorized user properly.

Further, when the HPD user ID is not registered yet, the system processing unit 310 boots the system from the standby state based on the fact that a face area is detected from among the captured images captured by the imaging unit 120 in the standby state.

Thus, when the HPD user ID is not registered yet, since it is not known whether or not the user is the authorized user, the information processing apparatus 1 boots the system both when the authorized user has approached and when any user other than the authorized user has approached, and then, the HPD user ID can be registered after authentication by the login authentication is successful if the user is the authorized user.

Further, after the system is booted up, when the face area is no longer detected from among the captured images captured by the imaging unit 120, the system processing unit 310 causes the system to make the transition to the standby state.

Thus, the information processing apparatus 1 can not only save power but also improve security when the information processing apparatus 1 is not used.

Further, even when the face area is detected from among the captured images captured by the imaging unit 120 after the system is booted up, the system processing unit 310 will cause the system to make the transition to the standby state if face authentication by the face authentication processing is unsuccessful.

Thus, the information processing apparatus 1 can not only save power but also improve security when the information processing apparatus 1 is not used by the authorized user.

Further, a control method for the information processing apparatus 1 according to one or more embodiments includes: a step of causing the face detection unit 210 (the example of the first processor) to perform face detection processing to detect an area (face area) of each of face images with a face captured therein from among captured images captured by the imaging unit 120; a step of causing the face detection unit 210 to perform face authentication processing to authenticate the face based on information (for example, the feature information) on the detected face image and information (for example, the feature information) on a face image of an authorized user; a step of causing the system processing unit 310 (for example, the CPU 301; the example of the second processor) to boot a system from a standby state by executing a program of the system based on the fact that the face area is detected by the above face detection processing and face authentication by the above face authentication processing is successful; a step of causing the system processing unit 310 to execute login authentication processing (the example of the system authentication processing) to authenticate whether or not the face image is the face image of the authorized user by processing of the system after the system is booted up; and a step of causing the face detection unit 210 to register, as information (for example, feature information) based on the face image of the above authorized user, information (for example, feature information) based on a face image when an orientation of the face becomes front (the example of the specific orientation) among face images detected by the above face detection processing within a predetermined time period (for example, within five seconds) after authentication by the above login authentication processing is successful.

Thus, upon using the face image of the user, detected when authentication by the login authentication is successful, as the face image of the authorized user for face authentication, since the face image with the face orientation taken into account is used for face authentication, the control method for the information processing apparatus 1 can authenticate the face of the authorized user properly.

While the embodiments of this invention have been described in detail above with reference to the accompanying drawings, the specific configurations are not limited to those in the embodiments described above, and design changes are also included without departing from the scope of this invention. For example, the respective components described in the above-described embodiments can be combined arbitrarily.

Note that the imaging unit 120 may also include either one of the IR camera and the RGB camera. For example, the configuration may be such that the IR camera is used in both the HPD processing and the login authentication processing, or that the RGB camera is used in both the HPD processing and the login authentication processing.

Further, the frame rate of the imaging unit 120 in each operating state and processing is just an example, and is not limited to each example of the frame rates described above. For example, in one or more embodiments, the frame rate in the HPD user registration/update processing may be set higher than the frame rates in the standby state and the normal operating state, but it may also be set to a frame rate different from the frame rate example described above.

Further, in the aforementioned embodiments, the configuration example in which the imaging unit 120 is built in the information processing apparatus 1 is described, but the present invention is not limited to this example. For example, the imaging unit 120 does not have to be built in the information processing apparatus 1, which may also be attachable to the information processing apparatus 1 (for example, onto any one of the side faces 10a, 10b, 10c, and the like) and communicably connected to the information processing apparatus 1 wirelessly or by wire as an external accessory of the information processing apparatus 1.

Further, the CPU 301 (an example of a third processor) and the chipset 303 (the example of the second processor) may be configured as individual processors, or configured to be integrated as one processor.

Further, in the aforementioned embodiments, the example in which the face detection unit 210 (the example of the first processor) is provided separated from the chipset 303 is illustrated, but some or all of the functions of the face detection unit 210 may be provided in the chipset 303, or may be provided in a processor integrated with the chipset 303. Further, the face detection unit 210, the chipset 303, and the CPU 301 may be configured to be integrated as one processor. Further, some or all of the functions of the face detection unit 210 may be provided in the EC 200.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the information processing apparatus 1, or delivery servers for delivering respective divided pieces of the program may be different from one another. Further, it is assumed that the “computer-readable recording medium” includes a medium on which the program is held for a given length of time, such as a volatile memory (RAN) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions of the information processing apparatus 1 in the embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

1 information processing apparatus
10 first chassis
20 second chassis
15 hinge mechanism
110 display unit
120 imaging unit
140 power button
150 input device
151 keyboard
153 touch pad
160 communication unit
170 storage unit
200 EC
210 face detection unit
211 face detection processing unit
212 face authentication processing unit
213 HPD user ID registration unit
214 HPD processing unit
300 main processing unit
301 CPU
302 GPU
303 chipset
304 system memory
310 system processing unit
311 operation control unit
312 authentication processing unit
330 HPD control processing unit
331 operation instruction unit
332 authentication result notification unit
400 power supply unit

What is claimed is:

1. An information processing apparatus comprising:
a memory which temporarily stores a program of a system;
a first processor which executes face detection processing to detect an area of each of face images with a face captured therein from among captured images captured by an imaging unit, and face authentication processing to authenticate the face based on information on the detected face image and information on a face image of an authorized user; and
a second processor which executes the program of the system to boot the system from a standby state based on a fact that the area of the face image is detected by the face detection processing and face authentication by the face authentication processing is successful, wherein
after the system is booted up, the second processor executes system authentication processing to authenticate whether or not the face image is the face image of the authorized user by processing of the system, and
the first processor registers, as the information based on the face image of the authorized user, information based on a face image when an orientation of the face becomes a specific orientation among face images detected by the face detection processing within a predetermined time period after authentication by the system authentication processing is successful.

2. The information processing apparatus according to claim 1, wherein the specific orientation is an orientation based on a direction of the imaging unit.

3. The information processing apparatus according to claim 2, wherein
the first processor detects a face angle of the face image detected from among the captured images within the predetermined time period, and determines that the orientation of the face becomes the specific orientation when the detected face angle is within a predetermined angle range based on the direction of the imaging unit.

4. The information processing apparatus according to claim 3, wherein the first processor increases a frequency of detecting areas of the face images from the captured images within the predetermined time period more than a frequency of detecting the areas of the face images from the captured images in the standby state.

5. The information processing apparatus according to claim 1, wherein upon registering the information based on the face image of the authorized user, the first processor newly registers the information when the information based on the face image of the authorized user is not registered yet, or updates the registered information when the information based on the face image of the authorized user is already registered.

6. The information processing apparatus according to claim 1, wherein when the information based on the face image of the authorized user is not registered yet, the second processor boots the system from the standby state based on the fact that the area of the face image is detected from among the captured images captured by the imaging unit in the standby state.

7. The information processing apparatus according to claim 1, wherein when the area of the face image is no longer detected from among the captured images captured by the imaging unit after the system is booted up, the second processor causes the system to make the transition to the standby state.

8. The information processing apparatus according to claim 1, wherein even when the area of the face image is detected from among the captured images captured by the imaging unit after the system is booted up, the second processor will cause the system to make the transition to the standby state if face authentication by the face authentication processing is unsuccessful.

9. A control method for an information processing apparatus including a memory which temporarily stores a program of a system, a first processor, and a second processor, the control method comprising:
a step of causing the first processor to perform face detection processing to detect an area of each of face images with a face captured therein from among captured images captured by an imaging unit;
a step of causing the first processor to perform face authentication processing to authenticate the face based on information on the detected face image and information on a face image of an authorized user;
a step of causing the second processor to boot the system from a standby state by executing the program of the system based on a fact that the area of the face image is detected by the face detection processing and face authentication by the face authentication processing is successful;
a step of causing the second processor to execute system authentication processing to authenticate whether or not the face image is the face image of the authorized user by processing of the system after the system is booted up; and
a step of causing the first processor to register, as the information based on the face image of the authorized user, information based on a face image when an orientation of the face becomes a specific orientation among face images detected by the face detection processing within a predetermined time period after authentication by the system authentication processing is successful.
